(19) United States
(12) Patent Application Publication
(10) Pub. No.: US 2004/0191287 A1
(43) Pub. Date: Sep. 30, 2004

(54) Fumigation process for stored food grains

(75) Inventors: Nadar Rajendran Somiah, Mysore (IN); Gunasekaran Nagamuthu, Mysore (IN)

Correspondence Address: LADAS & PARRY, 26 WEST 61st STREET, NEW YORK, NY, 10023, US

(73) Assignee: COUNCIL OF SCIENTIFIC AND INDUSTRIAL RESEARCH

(21) Appl. No.: 10/401,117

(22) Filed: Mar. 27, 2003

(51) Int. Cl. A01N 25/00

(52) U.S. Cl. 424/405

(57) ABSTRACT

Food grains during storage suffer qualitative and quantitative losses due to insect pest attack. Fumigation is the major control measure adopted through out the world. The major advantage of fumigation is that insects developing inside and outside the grain are controlled rapidly by the treatment. The prior art fumigants namely phosphine and methyl bromide are facing problems due to development of insect resistance or adverse effect on the environment. In this context ally acetate have been studied as potential fumigant.

### FIELD OF THE INVENTION

The present invention relates to a fumigation process for stored food grains. The main usage/utility of the process is control of insect pests such as Sitophilus oryzae (rice weevil). Rhyzopertha dominica (lesser grain borer), Cryptolestes sp. (grain beetle) and Tribolium castaneum (rust-red flour beetle) in stored food grains like wheat.

### BACKGROUND OF THE INVENTION

Reference is made to MBTOC (1998) (MBTOC (1998) United Nations Environment Programme (UNEP) Methyl Bromide Technical Options Committee (MBTOC) 1998 Assessment of the Alternatives to Methyl Bromide. UNEP, Nairobi, 358 pp.) Wherein the status of methyl bromide as a ozone depleting substance according to Montreal Protocol, an international treaty and the worldwide move to phase out the fumigant have been reported. Reference is also made to TEAP (2000) (TEAP (2000) UNEP Technology and Economic Assessment Panel (TEAP), 2000 Report of the Technology and Economic Assessment Panel 2000, UNEP, Nairobi, 193 pp.) wherein legislative changes made in different countries to control the use of methyl bromide fumigant has been reported and it is also stated that the ban on methyl bromide currently exempts quarantine and pre-shipment (QPS), emergency and certain critical uses.

Reference is made to Anon (2000) (Ozone depleting substances (Regulating and Control) Rules, 2000. The Gazette of India, Extraordinary, Part II-section 3 sub section (ii) No. 471. Ministry of Environment and Forests, Notification dated Jul. 19, 2000) wherein a legislative control banning the use of methyl bromide in India except for quarantine and pre-shipment treatments has been reported. Reference is made to Zettler et al (1984) (Zettler et al., (1984). Efficacy of perforated tubing in assisting phosphine distribution for In-transit fumigation of export corn. Journal of Economic Entomology 77,675-679) wherein phosphine fumigation of corn in ship hold in USA using perforated polyethylene tubing has been reported. The drawback with phosphine, a high vapour pressure gas, is that stored grain insects have developed resistance to that fumigant.

Reference is made to Subramanyam and Hagstrum (1996) (Subramanyam B and Hagstrum D W (1996) Resistance measurement and management. In: Integrated Management of Insects in Stored Products (Eds. B. Subramanyam and D. W. Hagstrum), Marcel Dekker Inc., New York. pp. 331-397.) wherein the occurrence of phosphine resistance in the major stored grain insect pests in various countries has been listed. Reference is made to Rajendran (1999) (Rajendran, S. (1999). Phosphine resistance in stored grain insect pests in India. In: Stored Product Protection: Proceedings of the 7th International Working Conference on Stored- Product Protection, October 1998,Beijing, China. (Jin Zuxun, Liang Quan, Liang Yongsheng, Tan Xianchang and Guan Lianghua. eds.), Sichuan Publishing House of Science and Technology, Chengdu, China, pp.635-641.) wherein instances of control failures in grain stack fumigations with phosphine due to the presence of phosphine resistant insects in India has been reported.

Reference is made to Rajendran (2001) (Rajendran S. (2001). Alternatives to methyl bromide as fumigants for stored food commodities. Pesticide Outlook, 12, 249-253.) wherein the implications to the safety/protection of stored food commodities against insect pests in the absence of phosphine and methyl bromide have been highlighted and the need to explore ways to protect the commodities with alternative fumigants that are safe to our food as well as the environment has been stressed. Reference is made to Banks et al., (2001) (Banks, H. G., Desmarchelier, F. J. M., Yonglin, R. Carbonyl sulphide insecticide. U.S. Pat. No. 6,203,824. Mar. 20, 2001) wherein carbonyl sulphide, an industrial gas, has been studied as a fumigant for stored products including food grain. The drawbacks of carbonyl sulphide are that the fumigant imparts off-odour to the treated commodity and affects germination. (Xianchan et al., 1999) (Xianchan, T., Xingwei, H., Lizheng C and Jianchun, W. (1999) Research on carbonyl sulfide as a fumigant for control of stored grain insects. In: Stored Product Protection: Proceedings of the 7th International Working Conference on Stored- Product Protection, October 1998,Beijing, China. (Jin Zuxun, Liang Quan, Liang Yongsheng, Tan Xianchang and Guan Lianghua. eds.), Sichuan Publishing House of Science and Technology, Chengdu, China, pp.635-641.

Reference is made to Choudhary et al., (2000) (Chaudhary, M. Q., Macnicoll, A. D., Price, N. R. Alkylphophines as pesticidal agents. U.S. Pat. No. 6,096,330. Aug. 1, 2000) wherein methyl phosphine has been studied for controlling stored grain insect pests. The drawbacks of methyl phosphine are that it is a gas under room temperatures and therefore it needs expertise to handle the fumigant even for small-scale fumigations. Reference is made to Jin Zuxun et al., (1999) (Jin Zuxun, Liang Quan, Liang yongsheng, Tan Xianchang and Guan Lianghua. (1999). Stored Product Protection: Proc 7^{th} Int Work Conf Stored Product Protection, Sichuan Publishing House of Science & Technology, Chengdu, People's Republic of China) wherein sulfuryl fluoride, which has been used as a structural fumigant for dry wood termite control for the past 40 years in USA, has been investigated for treating stored food commodities in China, Germany, UK and USA. The drawbacks of sulfuryl fluoride are (1) that the fumigant has high vapour pressure (13,442 mm of Hg at 25° C.) and is invariably handled in cylinders and therefore one needs expertise in handling the gas and (2) insect eggs are highly tolerant to sulfuryl fluoride.

Reference is made to Ohr et al., (1998) (Ohr, H. D., Grech, N. M., Sims, J. J. Methyl iodide as a fumigant. U.S. Pat. No. 5753,183. May 19, 1998) wherein methyl iodide has been studied as a stored product fumigant. A major drawback with methyl iodide is that it is a carcinogen. Reference is made to O'Brien et al., (1999) (O'Brein, I. G., Desmarchelier, F. J. M., Yonglin., R. Cyanogen fumigants and methods of fumigation using cyanogens. U.S. Pat. No. 6,001,383. Dec. 14, 1999) wherein cyanogen has been investigated as a fumigant for stored products including food grains and as a structural fumigant. The drawbacks of cyanogen are: 1) It is highly water-soluble and forms cyanide residues in treated commodities and 2) is highly toxic to human beings and involves risks in handling.

Reference is made to Shaaya et al., (1997) and Coats et al., (2001) (Shaaya, E., Kostukovski, M., Eilberg, J.and Sukprakarn, C. (1997) Plant oils as fumigants and contact insecticides for the control of stored- product insects. Journal of Stored Products Research, 33, 7-15) wherein natural products including essential oils containing monoterpenoides, thiosulphinates and cyanohydrins have been examined as fumigants for controlling insect pests of food grains. The drawbacks are that 1) these natural products have not been tested on food commodities, 2) the compounds have been reported to show low to moderate insect toxicity only and 3) a commercial product for application is yet to come. Reference is made to Burditt et al., (1963) (Burditt A. K. Jr, Hinman F. G. and Balock J. W. (1963). Screening of fumigants for toxicity to eggs and larvae of the Oriental fruit fly and Mediterranean fruit fly. Journal of Economic Entomology, 56, 261-265) wherein various compounds including esters have been tested for their fumigant property against Oriented fruit fly, Dacus dorsalis and Mediteranean fruit fly, Ceratitis capitata. However, the fumigant property of esters against stored grain insect pests has not been investigated. Reference is made to Weber et al., (1987) (Weber, J. D., Carroll, J. F and Hayes, D. K. (1987) Synthesis of acetols and esters of propargyl, propenyl and propyl alcohols and the bio-assay of these and related compounds as fumigants against Anastrepha suspensa (Loew) larvae. Journal of Stored Products Research 23, 1-7) wherein the fumigant action of allyl acetate, an ester, against the larvae of Caribbean fruit fly Anastrepha suspensa has been studied. However, the drawbacks are that the toxic action of allyl acetate against insect pests of stored food grains and about the application of the compound as a fumigant for stored food grains have not been investigated.

Allyl acetate (CAS No. 591-87-7) is a colourless liquid with acid odour. The pertinent properties of the compound and data on mammalian toxicity are given in Table 1.

TABLE 1
Physical, Chemical and Toxicological data* on allyl acetate

| | |
|---|---|
| Synonyms | 2-propenyl methenoate |
| | 3-acetoxy propene |
| | Acetic acid, 2 propenyl ester |
| CAS No. | 591-87-7 |
| Formula | C5H8O2 |
| Molecular weight | 100.12 |
| Boiling point (° C.) at 760 mm Hg | 103.5 |
| Vapour pressure at 27° C. (mm Hg) | 6 |
| Solubility in water | Insoluble |
| Density | |
| liquid (g/ml) | 0.928 |
| vapour (air = 1) | 3.45 |
| Flash Point (° C.) | 22.2 |
| Flammability in air | 1.1%-7.5% (Class 1C) |
| TLV-TWA (ppm) | 100 |
| Mammalian Toxicity | Toxic by inhalation, |
| | contact and ingestion; |
| | Irritating to eyes, respiratory |
| | system and skin |
| | LD 50 rat oral 130 mg/kg |
| | LC 50 rat inhalation 1000 ppm/1 hr |

*Anon (1999); HSDB (1991); Merck (1994); Sandmeyer and Kirwin (1981); Sax and Lewis (1989); RTECS (1991).

### OBJECTS OF THE INVENTION

The main object of the present invention is to provide a fumigation process for stored food grains, which obviates the drawbacks as detailed above.

Another object of the invention is to develop an alternative fumigant for stored protection against insect pests.

### SUMMARY OF THE INVENTION

Accordingly, the present invention provides a fumigation process for stored food grains which comprises dosing food grains contained in an air tight drum with allyl acetate through a hollow metal tubing provided extending from the top layer of the grains to the bottom layer of the grains, said metal tubing being provided with a plurality of evenly spaced holes provided on the surface thereof and extending into the interior of said tubing, an amount of the allyl acetate being dispensed in through to the bottom layer of the grain through the bottom of the hollow metal tubing and the balance amount of the ally acetate being dispensed to the top layer of the grain through the top end of the hollow metal tubing for effective penetration and distribution of the ally acetate through out the grain, the container being closed and sealed immediately after dosing.

In one embodiment of the invention, the food grains comprise wheat grains.

In another embodiment of the invention, the ally acetate is dosed into the food grains at the rate of 10 to 200 mg/litre of space and for a time period in the range of 24 to 72 hours.

In a further embodiment of the invention, the ally acetate is dosed into the food grains at the rate of about 200 mg/litre of space for 72 hours at 26±2° C.

In yet another embodiment of the invention, about 50% of the ally acetate is dispensed to the bottom layer of the grain through the bottom half of the hollow metal tubing and the balance is dispensed to the top layer of the grain through the top half of the hollow metal tubing.

In yet another embodiment of the invention, the ally acetate is dispensed in the form of a vapor through the grain to ensure better penetration thereof into the food grains.

In a further embodiment of the invention, a dosage of about 200 mg per litre of space of ally acetate substantially eradicates/kills all stages of Sitophilus oryzae (rice weevil), Rhyzopertha dominica (lesser grain borer) and Tribolium castaneum (rust-red flour beetle).

In a further embodiment of the invention, the hollow metal tubing extending from the bottom to the top layer of grain has a 2 cm internal diameter and has a plurality of 1 cm diameter holes spaced at 5 cm intervals all around the surface thereof.

### DETAILED DESCRIPTION OF THE INVENTION

The present invention provides a fumigation process for stored food grains which comprises treatment of food grains such as wheat in an air tight plastic drum with allyl acetate applied at the rate of 200 mg/litre for 72 hours at 26±2° C. and for effective penetration and distribution of the compound through out the grain mass a hollow metal tubing provided with 1 cm diameter holes distributed all over the tube at 5 cm intervals and extending from the bottom to the top layer of the grain has been used and 50% of the total dose of 200 mg/litre dispensed to the bottom layer of the grain through the hollow metal tube and the balance on the top layer of the grain and the container closed with the lid immediately after dosing and sealed around the rim with adhesive tape.

Allyl acetate is used as a fumigant for treating stored food grains (wheat) for the first time. A perforated hollow metal tubing is deployed in the storage container to facilitate dosing of chemical to the bottom layer of stored grain and to aid in distribution of allyl acetate vapour through out the grain mass. Allyl acetate is applied 50% to the bottom layer of the grain (wheat) through the perforated hollow metal tubing and another 50% on the top layer of the grain.

A dosage for 100% kill of all stages of Sitophilus oryzae (rice weevil), Rhyzopertha dominica (lesser grain borer) and Tribolium castaneum (rust-red flour beetle) is 200 mg of allyl acetate per litre of space. The preferred exposure period to control the pests indicated above is 72 hours.

Process:

An airtight plastic drum of 125-liter capacity is filled with 100 kg of food grain, wheat (moisture content 11.5%). Allyl acetate (pure grade from Merck) is used as the fumigant to control insect pests. A hollow (galvanized iron) metal tube of 64 cm length and 2 cm internal diameter and provided with 1 cm diameter holes distributed through out the tube at 5 cm intervals is inserted into the grain to reach the bottom. About 5 g of absorbent cotton wool is pushed into the tube so as to reach the bottom. Similarly about 5 g of absorbent cotton wool is placed on the top layer of the grain outside the tube. The cotton wool acts as an evaporating surface for allyl acetate liquid and it prevents localized sorption of the fumigant by the commodity. Allyl acetate is then applied to the commodity at the rate of 200 mg/litre. About 50% (13.5 ml) of the total quantity (27 ml) of allyl acetate liquid is taken in a 25 ml measuring cylinder and poured through the hollow tube to reach the cotton wool kept at the bottom layer of the grain. The other 50% (13.5 ml) is again measured in a measuring cylinder and poured on to the cotton wool kept on the top layer of the grain. The lid is immediately closed and is sealed along the rim with adhesive tape. The treated plastic drum is held for 72 hours at the laboratory temperature of 26±2° C. After 72 hours the drum is opened to allow aeration of the grain.

Dosage Calculations:

Volume of plastic drum=125 litre

Quantity of allyl acetate required for 200 mg/litre dosage=125×200=25000 mg=25 g

Density of allyl acetate liquid=0.93 g/ml

For 25.0 g of allyl acetate, the volume of the liquid to be taken=25×0.93=26.89 ml=27.0 ml

Allyl acetate has been used for the first time as a fumigant for the protection of stored food grain. As the compound has very low vapour pressure a device i.e. perforated hollow tubing has been used to dispense the fumigant to the bottom layer of the grain and to aid in uniform distribution of the toxic concentration of allyl acetate vapour in the grain mass to bring about 100% insect mortality at all levels during the exposure period of 72 hours under the experimental conditions of 26±2° C. The determined parameter including dosage (200 mg/litre) the exposure period (72 hours) and the split application of the compound and provision of perforated metal tubing extending from the bottom to the top layer of the are critical for a successful treatment of stored food grains. Any changes in the above parameters e.g., reduced dosage, reduced exposure period, application of the compound only on top or bottom layer of the grain and absence of perforated hollow metal tubing will lead to control failures and survival of insects in the fumigated grain.

The following examples are given by way of illustration of the present invention and therefore should not be constructed to limit the scope of the present invention.

### EXAMPLE1

Insects, Sitophilus oryzae and Rhyzopertha dominica were reared on whole wheat and Tribolium castaneum on whole-wheat flour plus 5% dried yeast according to the method described in FAO (1975). Cryptolestes sp. was reared on wheat feed. S. oryzae, Cryptolestes sp. and T. castaneum cultures were maintained at 25±1° C. and 70% RH whereas R. dominica cultures were maintained at 30±1° C. and 70% RH. From the established cultures, 2-week-old adults were taken and counted into 10 cm×2.3 cm size test tubes at 50 per replicate. The mouth of the tube was closed with a cloth piece held by small rubber ring. The insects were exposed to a range of doses (10 to 100 mg/litre) of esters for 24 hours in 0.85-liter desicators at the laboratory temperature of 26±2° C. Pure grade esters including allyl acetate, butyl acetate, ethyl acetoacetate, isopropyl acetate and propyl acetate were procured from Merck India Ltd. In each desiccator a 9 cm diameter Whatman No. 1 filter circle was placed; the filter circle acted as evaporating surface for the injected liquids (esters). Required quantity of the ester was drawn from the bottles using 10, 25 or 50 micro litre liquid syringe. There were 6 replicates for each dose with equal number of replicates for untreated control. The exposure period in all cases was 24 hours. At the end of the exposure period, the insects in the test tubes were transferred to another set of test tubes containing 20 g of wheat for S. oryzae and R. dominica and whole wheat flour plus 5% yeast for T. castaneum. Insect mortality was assessed after 14 days. Corrected mortality was arrived at based on Abbott's formula (1925). Final corrected mortality estimated for the insects exposed to different esters is given Table 2. The data shows that among the esters tested, allyl acetate proved to be the most toxic to all the three pests. The compound when applied at a dosage of ≧20 mg/litre for 24 hours caused 100% mortality of the adults of S. oryzae, R. dominica and T. castaneum.

TABLE 2
Toxicity of esters to adults of stored grain insect
pests (data are average of 6 replicates)

| Dosage | Mortality (%) (Mean ± SD) | | |
|---|---|---|---|
| (mg/L) | R. dominica | S. oryzae | T. castaneum |
| Allyl acetate | | | |
| 10 | 100 ± 0 | 92.3 ± 12.7 | 96.0 ± 3.7 |
| 20 | 100 ± 0 | 100 ± 0 | 100 ± 0 |
| 30 | 100 ± 0 | 100 ± 0 | 100 ± 0 |
| 50 | 100 ± 0 | 100 ± 0 | 100 ± 0 |
| 100 | 100 ± 0 | 100 ± 0 | 100 ± 0 |
| Butyl acetate | | | |
| 10 | 1.6 ± 3.5 | 8.3 ± 12.3 | 2.0 ± 2.6 |
| 20 | 0 | 1.7 ± 2.4 | 2.1 ± 1.1 |
| 30 | 0.2 ± 0.7 | 3.2 ± 4.5 | 0.6 ± 1.1 |
| 50 | 20.9 ± 26.8 | 67.3 ± 7.7 | 13.9 ± 0.8 |
| 100 | 100 ± 0 | 100 ± 0 | 96.2 ± 0.8 |
| Ethyl | | | |
| acetoacetate | | | |
| 10 | 0 | 3.1 ± 6.9 | 0.6 ± 2.6 |
| 20 | 0 | 4.7 ± 7.1 | 0.8 ± 1.1 |
| 30 | 5.7 ± 10.4 | 5.1 ± 5.7 | 0.3 ± 1.1 |
| 50 | 8.6 ± 17.1 | 6.5 ± 5.5 | 0.7 ± 0.8 |
| 100 | 0.4 ± 0.9 | 15.8 ± 14.0 | 1.3 ± 0.8 |
| Isopropyl | | | |
| acetate | | | |
| 10 | 4.4 ± 6.9 | 5.5 ± 6.9 | 0.3 ± 0.6 |
| 20 | 8.9 ± 10.7 | 2.3 ± 5.6 | 1.3 ± 1.7 |
| 30 | 6.1 ± 6.7 | 3.70 ± 7.56 | 32.71 ± 44.1 |
| 50 | 39.2 ± 8.2 | 47.1 ± 31.2 | 66.5 ± 27.7 |
| 100 | 100 ± 0 | 100 ± 0 | 100 ± 0 |
| Propyl | | | |
| acetate | | | |
| 10 | 2.0 ± 4.0 | 2.4 ± 3.8 | 0.9 ± 0 |
| 20 | 7.3 ± 10.0 | 0.5 ± 1.3 | 0.9 ± 0 |
| 30 | 5.3 ± 10.6 | 14.2 ± 8.1 | 12.6 ± 21.2 |
| 50 | 65.4 ± 40.0 | 74.3 ± 20.2 | 83.2 ± 26.3 |
| 100 | 100 ± 0 | 100 ± 0 | 100 ± 0 |
| Control | 19.2 ± 11.3 | 25.6 ± 6.1 | 2.0 ± 2.6 |

### EXAMPLE 2

Assays with allyl acetate against the adults of four species of stored grain insects namely S. oryzae, R. dominica, T. castaneum and Cryptolestes sp. were carried out to determine LD 50 and LD 99 doses. Sitophilus oryzae and Rhyzopertha dominica were reared on whole wheat and Tribolium castaneum on whole-wheat flour plus 5% dried yeast according to the method described in FAO (1975). Cryptolestes sp. was reared on wheat feed. S. oryzae, Cryptolestes sp. and T. castaneum cultures were maintained at 25±1° C. and 70% RH whereas R. dominica cultures were maintained at 30±1° C. and 70% RH. From the established cultures, 2-week-old adults were taken and counted into 10 cm×2.3 cm size test tubes at 50 per replicate. The mouth of the tube was closed with a cloth piece held by small rubber ring. Pure grade allyl acetate was procured from Merck India Ltd. In each desiccator a 9 cm diameter Whatman No. 1 filter circle was placed; the filter circle acted as evaporating surface for the injected allyl acetate liquid. Required quantity of the ester was drawn from the bottles using 10, 25, 50 and 100 micro litre liquid syringes. The insects were exposed to different doses of allyl acetate for 24 hour in 0.85-liter desiccators to yield 20-100% mortality. There were 6 replicates for each dose along with equal number of untreated control. At the end of the exposure period, the insects in the test tubes were transferred to another set of test tubes containing 20 g of wheat for S. oryzae and R. dominica and whole wheat flour plus 5% yeast for T. castaneum. Mortality of treated insects was assessed at the end of 14 days and it was corrected for natural control mortality. The data for the individual species were subjected to probit analysis following the method of Finney (1971) to arrive at LD 50 and LD 99 values. The data (Table 3) shows that among the adults, R. dominica was highly susceptible and T. castaneum was the most tolerant to allyl acetate.

TABLE 3
Toxicity of allyl acetate to adults of stored grain insect pests
in 24-hour exposure at 26 ± 2° C.

| | No. of Insects | | |
|---|---|---|---|
| Species | Tested | LD 50 (mg/Liter) | LD 99 (mg/Liter) |
| Cryptolestes | 720 | 271 (1.63; 3.21) | 5.44 (4.29; 15.6) |
| sp. | | | |
| R. dominica | 2000 | 1.69 (1.30; 2.02) | 7.56 (5.81; 11.67) |
| S. oryzae | 1750 | 4.08 (3.70; 4.42) | 12.81 (10.90; 16.15) |
| T. castaneum | 1750 | 6.14 (5.33; 6.80) | 11.42 (9.85; 14.92) |

### EXAMPLE 3

In still another set of experiments mixed-age cultures of R. dominica, S. oryzae and T. castaneum have been treated with allyl acetate for 24, 48 and 120 hours. Mixed-age cultures of S. oryzae and R. dominica were obtained by allowing 300 adults of the individual species to breed in about 1 kg of wheat in a 2-liter glass jar. To obtain mixed- age culture of T. castaneum about 300 adults were released into 1 kg of whole-wheat flour plus 5% dried yeast in a 2-litre glass jar. The insect culture jars were kept under the rearing temperature conditions i.e., 25±1° C. for S. oryzae and T. castaneum and 30±1° C. for R. dominica. The infested grain/flour after an incubation period of 7 weeks was used for the experiment. The grain/ flour containing mixed- age culture of the insect was weighted into 15 cm diameter paper plates in 50 gm aliquots and kept in 0.85 litre desiccators. A 9 cm size Whatman No.1 filter circle was placed in each desiccator to act as evaporating surface for allyl acetate when injected. The insects were exposed to 4 doses of allyl acetate i.e., 25, 50, 100 and 150 mg/liter. Allyl acetate was drawn from the bottle using 100 and 250 micro liter liquid syringes and injected into the desiccators, so that the liquid falls on the filter circle inside the desiccator. There were three replicates each for each dose and for each exposure period. At the end of the exposure period, the infested grain/flour from the paper plate was transferred to individual bottles and kept at the rearing conditions of temperature and humidity for 8 weeks. Insects emerged from wheat (S. oryzae and R. dominica) or survived in wheat flour (T. castaneum) samples were checked at weekly intervals for 8 weeks. Similarly, counts were made in untreated control batches. Mortality in treated batches was determined by taking into account of survival/emergence in controls as 100%. Average mortality of the insects following allyl acetate fumigation is given in Table 4. The data reveals that the life stages of R. dominica are highly susceptible to allyl acetate, whereas the developmental stages of T. castaneum are relatively tolerant. For example, allyl acetate at 25 mg/litre with 48-hour exposure caused 99.8% kill in R. dominica whereas, 85.1 and 86.5% mortality was recorded, respectively, in S. oryzae and T. castaneum. It is also evident that allyl acetate showed higher toxicity with increasing doses and at increasing exposure periods.

TABLE 4
Mortality (%) (Mean ± SD) of R. dominica, S. oryzae
and T. castaneum mixed-age cultures exposed to
allyl acetate for 24, 48 and 120 hours

| Exposure | | | | |
|---|---|---|---|---|
| period | Dosage (mg/liter) | | | |
| (hours) | 25 | 50 | 100 | 150 |
| R. dominica | | | | |
| 24 | 99.8 ± 0.3 | 100 ± 0 | 100 ± 0 | 100 ± 0 |
| 48 | 99.8 ± 0.4 | 99.8 ± 0.4 | 100 ± 0 | 100 ± 0 |
| 120 | 99.8 ± 0.5 | 100 ± 0 | 100 ± 0 | 100 ± 0 |
| S. oryzae | | | | |
| 24 | 87.9 ± 4.1 | 98.0 ± 1.5 | 100 ± 0 | 100 ± 0 |
| 48 | 85.1 ± 2.8 | 98.9 ± 1.3 | 100 ± 0 | 100 ± 0 |
| 120 | 98.8 ± 1.8 | 100 ± 0 | 100 ± 0 | 100 ± 0 |
| T. castaneum | | | | |
| 24 | 0 | 82.6 ± 17.8 | 98.4 ± 3.3 | 99.2 ± 1.7 |
| 48 | 86.5 ± 3.7 | 100 ± 0 | 100 ± 0 | 100 ± 0 |
| 120 | 51.4 ± 11.6 | 73.4 ± 17.7 | 97.3 ± 3.2 | 100 ± 0 |

### EXAMPLE 4

Fumigation experiments with allyl acetate have been conducted in 19.5 litre capacity tin containers with mixed- age cultures of R. dominica, S. oryzae and T. castaneum as the test insects.

Mixed-age cultures of S. oryzae and R. dominica were obtained by allowing 300 adults of the individual species to breed in about 1 kg of wheat in a 2-liter glass jar. To obtain mixed- age culture of T. castaneum about 300 adults were released into 1 kg of whole-wheat flour plus 5% dried yeast in a 2-litre glass jar. The insect culture jars were kept under the rearing temperature conditions i.e., 25±1° C. for S. oryzae and T. castaneum and 30±1° C. for R. dominica.

The infested grain/flour after an incubation period of 7 weeks was used for the experiment. The cultures were weighed into 50 gm aliquots in 21 cm×14 cm size cloth bags. One set of three test insect bags comprising R. dominica, S. oryzae and T. castaneum were kept at the bottom of the container before filling the grain. Each container was filled with 12 kg of wheat (11.5% moisture content).

Another set of three-test insect bags was kept on the top layer of grains. The grain-filled containers were, then, fumigated with allyl acetate for 72 hours at 26±2° C. There were 6 doses ranging from 100 to 800 mg/litre with 3 replicates/dosage along with untreated controls. Required quantity of allyl acetate was measured in 10 and 25 ml measuring cylinder and quickly poured on to 5 gm of absorbent cotton wool kept over the grain layer in the tin container.

Immediately after dosing, the container was closed with the lid tightly and sealed along the rim with adhesive tape. At the end of 72 hour, the lid was removed to aerate the commodity and the test insect bags were retrieved and the contents transferred to 300 ml capacity glass bottles.

Insect survivors in the samples were recorded at weekly intervals for 8 weeks. Mortality in fumigated batches was calculated based on emergence/survivors in controls. The data on survivors and % mortality are presented in Table 5. Dosage of 200 mg/litre proved effective against the pests. Allyl acetate applied on top layer of the grain penetrated to the bottom layer of the commodity where one set of test insect bags has been kept. Table 5. Number of survivors and % kill in mixed-age insect cultures samples following fumigation with allyl acetate for 72 hours at 26±2° C. in 19.5 liter tin container filled with 12 kg wheat

TABLE 5

| | No. of survivors from 50 g lots | | | | | |
|---|---|---|---|---|---|---|
| | of mixed-age cultures following treatment | | | | | |
| Dosage (mg/liter) | S. oryzae | | R. dominica | | T. castaneum | |
| 100 | 11.5 | (98.9) | 0 | (100) | 0 | (100) |
| 150 | 1 | (99.9) | 0 | (100) | 0 | (100) |
| 200 | 0 | (100) | 0 | (100) | 0 | (100) |
| 400 | 0 | (100) | 0 | (100) | 0 | (100) |
| 600 | 0 | (100) | 0 | (100) | 0 | (100) |
| 800 | 0 | (100) | 0 | (100) | 0 | (100) |
| Control | 1033.5 | | 198.25 | | 38.25 | |

Data are average of 3 replicates. Figures in parentheses are % mortality based or survivors in controls

### EXAMPLE 5

Further fumigation tests were carried out with allyl acetate at 200 mg/litre and with three different exposure periods of 24, 48 and 72 hours in 19.5 litre tin containers filled with 12 kg of wheat. Mixed- age cultures of R. dominica, S. oryzae and T. castaneum were used as the test insects.

Mixed-age cultures of S. oryzae and R. dominica were obtained by allowing 300 adults of the individual species to breed in about 1 kg of wheat in a 2-liter glass jar. To obtain mixed- age culture of T. castaneum about 300 adults were released into 1 kg of whole-wheat flour plus 5% dried yeast in a 2-litre glass jar. The insect culture jars were kept under the rearing temperature conditions i.e., 25±1° C. for S. oryzae and T. castaneum and 30±1° C. for R. dominica. The infested grain/flour after an incubation period of 7 weeks was used for the experiment. The cultures were weighed into 50 gm aliquots in 21 cm×14 cm size cloth bags. One set of three test insect bags comprising R. dominica, S. oryzae and T. castaneum were kept at the bottom of the container before filling the grain. Each container was filled with 12 kg of wheat (11.5% moisture content). Another set of three-test insect bags was kept on the top layer of grains. The grain-filled containers were, then, fumigated with allyl acetate for 24, 48 and 72 hours at 26±2° C. The commodity was treated with allyl acetate at the dosage of 200 mg/litre. Required quantity of allyl acetate was measured in 10 and 25 ml measuring cylinder and quickly poured on to 5 gm of absorbent cotton wool kept over the grain layer in the tin container. Immediately after dosing, the container was closed with the lid tightly and sealed along the rim with adhesive tape. At the end of the exposure period, the lid was removed to aerate the commodity and the test insect bags were retrieved and the contents transferred to 300 ml capacity glass bottles. Insect survivors in the samples were recorded at weekly intervals for 8 weeks. Mortality in fumigated batches was calculated based on emergence/survivors in controls.

The data on survivors in test insect bags containing mixed-age cultures are given in Table 6. It is well established that allyl acetate at a dosage of 200 mg/litre is effective against the pests only when the exposure period was not less than 72 hours.

TABLE 6
Number of survivors in test insect bags after fumigation
with allyl acetate at 200 mg/liter at 26 ± 2° C.
in 19.5 liter tin containers filled with 12 kg of wheat

| | |
|---|---|
| | No. of survivors from 50 g lots |
| | of mixed-age cultures |
| Exposure | following treatment |

| period (hour) | S. oryzae | | R. dominica | | T. castaneum | |
|---|---|---|---|---|---|---|
| 24 | 0.33 | (99.9) | 0 | (100) | 0 | (100) |
| 48 | 0.33 | (99.9) | 0 | (100) | 0 | (100) |
| 72 | 0 | (100) | 0 | (100) | 0 | (100) |
| Control | 356.5 | | 223.0 | | 20.0 | |

Data are average of 3 replicates.

Figures in parentheses are the % mortality based or survivors in controls

### EXAMPLE 6

Fumigation tests with allyl acetate have been carried out in a larger container i.e., plastic drum of 125 litre capacity filled with 100 kg of wheat (moisture content 11.5%) at 26±2° C. for 72 hours.

Mixed-age cultures of S. oryzae and R. dominica were obtained by allowing 300 adults of the individual species to breed in about 1 kg of wheat in a 2-liter glass jar. To obtain mixed- age culture of T. castaneum about 300 adults were released into 1 kg of whole-wheat flour plus 5% dried yeast in a 2-litre glass jar. The insect culture jars were kept under the rearing temperature conditions i.e., 25±1° C. for S. oryzae and T. castaneum and 30±1° C. for R. dominica. The infested grain/flour after an incubation period of 7 weeks was used for the experiment. The cultures were weighed into 50 gm aliquots in 21 cm×14 cm size cloth bags. One set of 3 test insect bags each containing one species was kept at the bottom of the plastic drum before filling the grain. Fifty kg of wheat was weighed into each drum. Now, another set of 3 test insect bags were placed on the grain inside the drum. Then, another 50 kg of wheat was weighed into each drum. On the top layer of 100 kg grain, one more set of three test insect bags comprising three species were placed. In each drum, a hollow (galvanized iron) metal tubing of 64 cm length and 2 cm internal diameter was inserted to reach the bottom of the drum and the tube is provided with perforations of 1 cm diameter and the perforations distributed all along the tube at 5 cm intervals. About 5 gm of absorbent cotton wool was pushed inside the tube to reach its bottom. Another 5 g of cotton wool was kept on the top of the grain. Required quantity of allyl acetate was taken in a 25 ml measuring cylinder. Allyl acetate was dispensed 50% to the bottom layer through the perforated tubing and the remaining 50% on the top layer of the grain. The liquid, 13.5 ml, each was poured on the cotton wool kept on the top layer of the grain and at the bottom inside the perforated piping. Immediately after dosing, the drum was closed with the lid and was sealed along the rim with adhesive tape. At the end of 72-hour exposure period, the drum was opened and test insect bags kept at top, middle and bottom layer of grain were retrieved after pouring the grain out. The mixed- age culture samples from treated and control batches were transferred to individual bottles and kept under rearing conditions.

In another set of experiments, fumigations were carried out in the plastic drums with 100 kg of wheat under similar conditions mentioned above except that there was no perforated tubing inserted into the grain and the total dose of allyl acetate (27 ml of liquid) was dispensed at one location, that is, on the top layer of the grain. In both sets of experiments, there were 3 replicates for control and fumigated batches.

Survivors noted as active stages in T. castaneum and adults emerged in S. oryzae and R. dominica from fumigated and control samples were checked at weekly intervals for 8 consecutive weeks. Insect mortality in fumigated batches was determined by taking into consideration of survivors in respective controls as 100%.

Data on survivors and % kill are presented in Table 7. The data shows that when perforated tubing was used and when split application of allyl acetate at two locations (bottom and top layer of the grain) was done, the fumigant could penetrate throughout the grain to achieve 100% insect mortality. In the absence of perforated tubing and total volume of allyl acetate was applied only at one location (top layer of the grain), the fumigation was not successful and there were survivors at the middle and bottom layer of the grain. Due to its low vapour pressure, allyl acetate applied on the top layer could not reach the bottom layer of grain to kill the insects.

Fumigation with allyl acetate at 200 mg/litre and 72-hour exposure period is effective in the drums having perforated tubing and the fumigant dispensed 50% to the bottom layer and another 50% on the top layer of the grain. The perforated tubing and split application of the fumigant at top and bottom levels are necessary for an effective treatment of stored food grain, wheat.

TABLE 7
Survivors in fumigation tests with allyl acetate dosed
at 200 mg/liter for 72 hours at 26 ± 2° C. in
125 liter plastic drums filled with 100 kg of wheat load

| Location of test | Insect Survivors | | |
|---|---|---|---|
| insect bag | S. oryzae | R. dominica | T. castaneum |

Without perforated tubing

| | | | | | | |
|---|---|---|---|---|---|---|
| Treated | | | | | | |
| Top layer | 0 | (100) | 0 | (100) | 0.33 | (99.4) |
| Middle layer | 0.33 | (99.9) | 0 | (100) | 0 | (100) |
| Bottom layer | 22.33 | (95.3) | 0.67 | (99.6) | 39.00 | (0) |
| Control | | | | | | |
| Top layer | 509 | | 157 | | 59 | |
| Middle layer | 561 | | 194 | | 39 | |
| Bottom layer | 472 | | 150 | | 38 | |

With perforated tubing

| | | | | | | |
|---|---|---|---|---|---|---|
| Treated | | | | | | |
| Top layer | 0 | (100) | 0 | (100) | 0 | (100) |
| Middle layer | 0 | (100) | 0 | (100) | 0 | (100) |
| Bottom layer | 0 | (100) | 0 | (100) | 0 | (100) |
| Control | | | | | | |
| Top | 640 | | 104 | | 29 | |
| Middle | 574 | | 133 | | 19 | |
| Bottom | 695 | | 136 | | 28 | |

Data are average of 3 replicates. Figures in parentheses are % mortality based or survivors in untreated controls.

A process for fumigating food grains with an alternative fumigant i.e., allyl acetate, has been developed. Effective dosage, exposure period and utilization of device for uniform distribution of allyl acetate during the treatment of stored food grain, wheat, have been established for the first time.

The main advantages of the present invention are:

1. An alternative compound i.e., allyl acetate has been deployed as a fumigant for insect control.

2. Allyl acetate is not an ozone depleting substance and is not carcinogenic.

3. Using perforated hollow metal tubing, the distribution and penetration of allyl acetate, a low vapour pressure compound, through out the commodity has been ensured.

4. Insect pests of stored grain are controlled by the compound with a moderate exposure period of 72 hours at 26±2° C.

### REFERENCES

Patents

Banks, H. G., Desmarchelier, F. J. M., Yonglin, R. Carbonyl sulphide insecticide. U.S. Pat. No. 6,203,824. Mar. 20, 2001.

Chaudhary, M. Q., Macnicoll, A. D., Price, N. R. Alkylphophines as pesticidal agents. U.S. Pat. No. 6,096,330. Aug. 1, 2000.

Coats, J. R., Peterson C. J., Tsao, R., Aggler A. L., Tylka G. L. Biopesticides related to natural sources. U.S. Pat. No. 6,207,705. Mar. 27, 2001.

O'Brein, I. G., Desmarchelier, F. J. M., Yonglin., R. Cyanogen fumigants and methods of fumigation using cyanogens. U.S. Pat. No. 6,001,383. Dec. 14, 1999.

Ohr, H. D., Grech, N. M., Sims, J. J. Methyl iodide as a fumigant. U.S. Pat. No. 5,753,183. May 19, 1998.

Other References

Abbott, W S (1925). Method for computing the effectiveness of an insecticide. Journal of Economic Entomology 18, 265-267.

Anon. (1999) Chemical Hazards Response Information system: Hazardous Chemical Data Manual. Transportation Department, Coast Guard, USA, 2890 pp.

Anon. (2000). Ozone depleting substances (Regulating and Control) Rules, 2000. The Gazette of India, Extraordinary, Part II-section 3 sub section (ii) No. 471. Ministry of Environment and Forests, Notification dated Jul. 19, 2000.

Burditt A. K. Jr, Hinman F. G. and Balock J. W. (1963). Screening of fumigants for toxicity to eggs and larvae of the Oriental fruit fly and Mediterranean fruit fly. Journal of Economic Entomology, 56, 261-265.

FAO (1975). Recommended methods for the detection and measurements of resistance of agricultural pests to pesticides. FAO Method No. 16, FAO Plant Protection Bulletin 23, 12-25.

Jin Zuxun, Liang Quan, Liang yongsheng, Tan Xianchang and Guan Lianghua. (1999). Stored Product Protection: Proc 7^{th} Int Work Conf Stored Product Protection, Sichuan Publishing House of Science & Technology, Chengdu, People's Republic of China.

HSDB (1991) Hazardous Substances Data Bank: Allyl Alcohol; Acetic acid, Allyl Ester. National Library of Medicine, Bethesda, Md., September 1991.

MBTOC (1998) United Nations Environment Programme (UNEP) Methyl Bromide Technical Options Committee (MBTOC) 1998 Assessment of the Alternatives to Methyl Bromide. UNEP, Nairobi, 358 pp.

Merck (1994). The Merck Chemical database-online. Website www.chemdat.merck.de. accessed on Dec. 13, 2001.

Rajendran, S. (1999). Phosphine resistance in stored grain insect pests in India. In: Stored Product Protection: Proceedings of the 7th International Working Conference on Stored-Product Protection, October 1998,Beijing, China. (Jin Zuxun, Liang Quan, Liang Yongsheng, Tan Xianchang and Guan Lianghua. eds.), Sichuan Publishing House of Science and Technology, Chengdu, China, pp.635-641.

Rajendran S. (2001). Alternatives to methyl bromide as fumigants for stored food commodities. Pesticide Outlook, 12, 249-253.

RTECS (1991) Registery of Toxic Effects of Chemical Substances Database: Acetic acid, Allyl ester. National Library of Medicine, Bethesda, Md., September 1991.

Sandmeyer, E. E. and Kirwin, C. J. (1981) Esters. In: Clayton, G. D. and Clayton, F. E., eds., Patty's Industrial Hygiene and Toxicology, 3^{rd} Ed., New York, John Wiley & Sons, pp. 2268-2269, 2280.

Sax, N. I. and Lewis, R. J. (1987) Hazardous Chemicals Desk Reference, New York, Van Nostrand Reinhold, pp. 135.

Shaaya, E., Kostukovski, M., Eilberg, J.and Sukprakarn, C. (1997) Plant oils as fumigants and contact insecticides for the control of stored- product insects. Journal of Stored Products Research, 33, 7-15.

Subramanyam B and Hagstrum D W (1996) Resistance measurement and management. In: Integrated Management of Insects in Stored Products (Eds. B. Subramanyam and D. W. Hagstrum), Marcel Dekker Inc., New York. pp. 331-397.

TEAP (2000) UNEP Technology and Economic Assessment Panel (REAP), 2000 Report of the Technology and Economic Assessment Panel 2000, UNEP, Nairobi, 193 pp.

Weber, J. D., Carroll, J. F and Hayes, D. K. (1987) Synthesis of acetols and esters of propargyl, propenyl and propyl alcohols and the bio-assay of these and related compounds as fumigants against Anastrepha suspensa (Loew) larvae. Journal of Stored Products Research 23, 1-7.

Xianchan, T., Xingwei, H., Lizheng C and Jianchun, W. (1999) Research on carbonyl sulfide as a fumigant for control of stored grain insects. In: Stored Product Protection: Proceedings of the 7th International Working Conference on Stored- Product Protection, October 1998,Beijing, China. (Jin Zuxun, Liang Quan, Liang Yongsheng, Tan Xianchang and Guan Lianghua. eds.), Sichuan Publishing House of Science and Technology, Chengdu, China, pp.635-641.

We claim:

1. A fumigation process for stored food grains which composes dosing food grains contained in an air tight drum with allyl acetate through a hollow metal tubing provided extending from the top layer of the grains to the bottom layer of the grains, said metal tubing being provided with a plurality of evenly spaced holes provided on the surface thereof and extending into the interior of said tubing, an amount of the allyl acetate being dispensed in through to the bottom layer of the grain through the bottom of the hollow metal tubing and the balance amount of the ally acetate being dispensed to the top layer of the grain through the top end of the hollow metal tubing for effective penetration and distribution of the ally acetate through out the grain, the container being closed and sealed immediately after dosing.

2. A fumigation process as claimed in claim 1 wherein the food grains comprise wheat grains.

3. A process as claimed in claim 1 wherein the ally acetate is dosed into the food grains at the rate of 10 to 200 mg/litre of space and for a time period in the range of 24 to 72 hours.

4. A fumigation process as claimed in claim 1 wherein the ally acetate is dosed into the food grains at the rate of about 200 mg/litre of space for 72 hours at 26±2° C.

5. A process as claimed in claim 1 wherein about 50% of the ally acetate is dispensed to the bottom layer of the grain through the bottom half of the hollow metal tubing and the balance is dispensed to the top layer of the grain through the top half of the hollow metal tubing.

6. A process as claimed in claim 1 wherein the ally acetate is dispensed in the form of a vapor through the grain to ensure better penetration thereof into the food grains.

7. A process as claimed in claim 1 wherein a dosage of about 200 mg per litre of space of ally acetate substantially eradicates/kills all stages of Sitophilus oryzae (rice weevil), Rhyzopertha dominica (lesser grain borer) and Tribolium castaneum (rust-red flour beetle).

8. A process as claimed in claim 1 wherein the hollow metal tubing extending from the bottom to the top layer of grain has a 2 cm internal diameter and has a plurality of 1 cm diameter holes spaced at 5 cm intervals all around the surface thereof.
